(19) United States
(12) Patent Application Publication
(10) Pub. No.: US 2010/0055255 A1
(43) Pub. Date: Mar. 4, 2010

(54) Sweetener Compositions and Methods for Their Manufacture

(76) Inventors: John Doyle, Oak Park, IL (US); Sergio Machado, Oswego, IL (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 12/547,935

(22) Filed: Aug. 26, 2009

Related U.S. Application Data
(60) Provisional application No. 61/091,987, filed on Aug. 26, 2008.

(51) Int. Cl. A23L 1/236; A23L 1/48; B65D 85/00

(52) U.S. Cl. 426/96; 426/548; 426/302; 426/106

(57) ABSTRACT

Disclosed are sweetener compositions that comprise rebaudioside A and have a taste profile, mouthfeel, texture, and other physical properties comparable to that of caloric sweeteners.

### CROSS-REFERENCE TO RELATED APPLICATIONS

This application claims the benefit of U.S. Provisional Application No. 61/091,987, filed Aug. 26, 2008, the disclosure of which is incorporated herein by reference in its entirety.

### FIELD OF THE INVENTION

The invention relates to tabletop sweetener compositions that comprise rebaudioside A and have a taste profile that is similar to that of sucrose. Further, the invention relates to methods of manufacturing such a sweetener composition.

### BACKGROUND OF THE INVENTION

Tabletop sweeteners enjoy wide use both by consumers and by the food and beverage industry. Consumers use such sweeteners as an ingredient in various food items, but also use such sweeteners to customize the sweetness of beverages, fruit, yogurt, and the like. The food and beverage industry uses such sweeteners in prepared beverages and other food items. Tabletop sweeteners include both caloric and low-caloric sweeteners. Typical caloric sweeteners for use in tabletop sweeteners include sucrose, fructose, and glucose. Common tabletop forms of such sweeteners include cane sugar, beet sugar, high-fructose corn syrup, and the like. In recent decades, low-calorie (or non-calorie) sweeteners have gained increasing popularity. In many instances, these sweeteners can be used as substitutes for caloric sweeteners and are often referred to as “sugar substitutes.” Common sugar substitutes include saccharin, aspartame, and sucralose. In parts of Asia, compounds extracted from stevia plants have also been used as sugar substitutes. Of the various compounds present in these stevia extracts, rebaudioside A (commonly referred to as “Reb A”) is generally considered to exhibit the greatest utility as a sugar substitute.

In many instances, sugar substitutes provide a greater sweetening effect than comparable amounts of caloric sweeteners, such as sucrose or fructose. Therefore, smaller amounts of sugar substitutes are required to achieve a sweetness comparable to that of an amount of sugar. Moreover, sugar substitutes typically have a taste profile that differs from sucrose or fructose. Such differences include, but are not limited to, increased astringency, bitterness, various aftertastes, delayed onset of sweetness, and different mouthfeel. Therefore, sugar substitutes are often formulated with other materials that can provide bulk and can enhance the taste profile to be more similar to that of sucrose or fructose. Thus, sugar substitutes have been formulated, for example, with various combinations of dextrins, polyols, amino acids, etc. to create a tabletop sweetener formulation that has a bulk and a taste profile that is comparable to sucrose or fructose. Nevertheless, consumers can still generally distinguish these low-calorie sweetener formulations from caloric tabletop sweeteners. Therefore, if low-calorie tabletop sweeteners are to replace caloric tabletop sweeteners, formulations of low-calorie sweeteners must be continually improved to meet consumer demand for sugar substitutes that reasonably approximate the taste, texture, and mouthfeel of sucrose and/or fructose.

There is an increasing interest in such sweeteners containing natural ingredients. This interest stems partially from increasing consumer interest in such products, but also from the rise of retail and internet stores selling natural products, and requiring suppliers of such products to certify that natural ingredients are used in any products being supplied.

Therefore, there is a need for new tabletop sweetener formulations that are low in calories (or have no calories) and that can reasonably approximate the taste profile, mouthfeel, and texture of caloric sweeteners. Moreover, there is a need for new methods of formulating such low-calorie or no-calorie sweeteners.

### SUMMARY OF THE INVENTION

The invention provides sweetener compositions that comprise rebaudioside A and have a taste profile, mouthfeel, and texture comparable to that of caloric sweeteners. In particular, the invention provides sweetener compositions that more closely approximate the taste, mouthfeel, and texture of sugar than other low-calorie sweetener compositions that contain rebaudioside A. Further, the invention provides methods of manufacturing sweetener compositions that comprise rebaudioside A and have a taste profile, mouthfeel, and texture comparable to that of caloric sweeteners. Further, the invention provides methods of using sweetener compositions to sweeten a consumable product, such as a beverage or solid food item. Further, the invention provides a packaged sweetener formulation or a food product sweetened with sweetener compositions.

In a first aspect, the invention provides a sweetener composition comprising: (a) a disaccharide carbohydrate; (b) erythritol; (c) rebaudioside A; and (d) a taste-improving amount of cellulose.

In a second aspect, the invention provides a sweetener composition comprising: (a) a disaccharide carbohydrate or fructose; (b) erythritol, honey, or evaporated cane juice; (c) rebaudioside A; and (d) a taste-improving amount of cellulose.

In a third aspect, the invention provides sweetener composition comprising: (a) a plurality of first sweetener particles, where the first sweetener particles have (i) an erythritol core, (ii) a first erythritol core-coating layer comprising rebaudioside A and cellulose, and (iii) a second erythritol core-coating layer comprising a disaccharide carbohydrate, where the second erythritol core-coating layer lies outside of the first erythritol core-coating layer; and (b) a plurality of second sweetener particles, where the second sweetener particle has (i) a disaccharide core, (ii) a first disaccharide core-coating layer comprising rebaudioside A and cellulose, and (iii) a second disaccharide core-coating layer comprising a disaccharide carbohydrate, where the second disaccharide core-coating layer lies outside of the first disaccharide core-coating layer.

In a fourth aspect, the invention provides a sweetener comprising rebaudioside A and a taste-improving amount of cellulose as a mixture, where the mixture comprises (a) particles having an erythritol core and (b) particles having a disaccharide core.

In yet another aspect, the invention provides a method of manufacturing a sweetener composition comprising: (a) providing a fluid-bed coating apparatus; (b) introducing dry disaccharide carbohydrate, dry erythritol, dry rebaudioside A, and dry cellulose powder to the fluid-bed coating apparatus; (c) charging substantially all of the dry ingredients in the fluid-bed coating apparatus; (d) coating a substantial portion of the dry ingredients in the fluid-bed coating apparatus with a disaccharide solution so as to form disaccharide-coated sweetener particles; and (e) drying the disaccharide-coated sweetener particles.

In a further aspect, the invention provides a method of manufacturing a sweetener composition comprising: (a) providing a fluid-bed coating apparatus; (b) introducing dry disaccharide carbohydrate, dry erythritol, and dry rebaudioside A to the fluid-bed coating apparatus; (c) charging a substantially all of the dry ingredients in the fluid-bed coating apparatus; (d) coating a substantial portion of the dry ingredients in the fluid-bed coating apparatus with a disaccharide solution so as to form disaccharide-coated sweetener particles; (e) during the coating step, introducing dry cellulose powder to the fluid-bed coating apparatus; and (f) drying the disaccharide-coated sweetener particles.

In still another aspect, the invention provides a method for using a sweetener composition comprising: (a) providing a sweetener composition according to any of the first through fourth aspects of the invention; and (b) introducing the sweetener composition to a consumable product to be sweetened.

In a related aspect, the invention provides a method for sweetening a consumable product comprising adding a sweetener composition according to any of the first through the fourth aspects of the invention to the consumable product.

In another aspect, the invention provides a packaged sweetener formulation comprising a sweetener composition according to any of the first through the fourth aspects of the invention.

In an aspect, the invention provides a food product comprising a sweetener composition according to any of the first through the fourth aspects of the invention.

The products of the invention may be used as, or added to, a wide variety of foods. For example, the products may be used as tabletop sweetener products or as dietary supplements.

In another aspect, the invention provides a sweetener composition, particularly a tabletop sweetener product, comprising: (a) from about 30 weight percent to about 43 weight percent of isomaltulose; (b) from about 50 weight percent to about 70 weight percent erythritol; (c) from about 0.75 weight percent to about 1.75 weight percent rebaudioside A; and (d) from about 0.5 weight percent to about 1.5 weight percent cellulose. In a related aspect, the sweetener product is packaged in an amount of from about 0.8 grams to about 3.5 grams to provide an equivalent sweetness to about 4 grams to about 8 grams of sucrose.

In still another aspect, the invention provides a sweetener composition, particularly a tabletop sweetener product, comprising: (a) from about 30 weight percent to about 38 weight percent of isomaltulose; (b) from about 55 weight percent to about 65 weight percent erythritol; (c) from about 0.75 weight percent to about 1.75 weight percent rebaudioside A; and (d) from about 0.5 weight percent to about 1.5 weight percent cellulose. In a related aspect, the sweetener product is packaged in an amount of from about 0.8 grams to about 3.5 grams to provide an equivalent sweetness to about 4 grams to about 8 grams of sucrose.

In a further aspect, the invention provides a tabletop sweetener product comprising: (a) from about 38 weight percent to about 43 weight percent of isomaltulose; (b) from about 50 weight percent to about 60 weight percent erythritol; (c) from about 0.75 weight percent to about 1.75 weight percent rebaudioside A; and (d) from about 0.5 weight percent to about 1.5 weight percent cellulose. In a related aspect, this sweetener product is packaged in an amount of from about 0.8 grams to about 3.5 grams to provide an equivalent sweetness to about 4 grams to about 8 grams of sucrose.

In another aspect, the invention provides a package containing a predetermined amount of from about 0.8 grams to about 3.5 grams of a solid sweetener composition, where the predetermined amount of the solid sweetener composition has a sweetness equivalent to about four times (by weight) the predetermined amount of sucrose, and where the solid sweetener composition comprises: (a) from about 30 weight percent to about 43 weight percent of isomaltulose; (b) from about 50 weight percent to about 60 weight percent erythritol; (c) from about 0.75 weight percent to about 1.75 weight percent rebaudioside A; and (d) from about 0.5 weight percent to about 1.5 weight percent cellulose.

Tabletop sweetener products of the invention are suitable for use within a packaging selected from the group consisting of sachets, sticks, jars, tablets, and bags.

### BRIEF DESCRIPTION OF THE DRAWINGS

FIG. 1 provides an illustration of typical sweetener particles that may be present in various embodiments of the invention.

FIG. 2 provides an illustration of typical coating process carried out according to various embodiments of the invention.

### DETAILED DESCRIPTION

The invention provides sweetener compositions that comprise rebaudioside A and have a taste profile, mouthfeel, texture, and other physical properties comparable to that of caloric sweeteners. Further, the invention provides methods of manufacturing sweetener compositions that comprise rebaudioside A and have a taste profile, mouthfeel, and texture comparable to that of caloric sweeteners. Further, the invention provides methods of using sweetener compositions to sweeten a consumable product, such as a beverage or solid food item. Further, the invention provides a packaged sweetener formulation or a food product sweetened with sweetener compositions.

All publications, patent applications, patents, and other references mentioned herein, if not otherwise indicated, are incorporated by reference in their entirety for any and all purposes as if fully set forth.

Unless otherwise defined, all technical and scientific terms used herein have the same meaning as commonly understood by one of ordinary skill in the art to which the invention belongs. In case of any direct conflict, the present specification, including definitions, controls.

Although methods and materials similar or equivalent to those described herein can be used in the practice or testing of the present invention, suitable methods and materials are described herein. Such suitable methods and materials are provided as examples, however, and are not intended to restrict the scope of any claim or claim term.

Unless stated otherwise, all percentages, parts, ratios, etc. are by weight.

When an amount, concentration, or other value or parameter is given as a range, or as a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present invention be limited to the specific values recited when defining a range. When the term “about” is used in describing a value or an endpoint of a range, the invention should be understood to include the specific value or endpoint referred to.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited only to the recited elements, but can include other elements not expressly recited or inherent to such process, method, article, or apparatus. Further, unless expressly stated to the contrary, “or” refers to an inclusive or, and not to an exclusive or. For example, a condition A or B is satisfied by any one of the following: A is true (or present) and B is false (or not present); A is false (or not present) and B is true (or present); and both A and B are true (or are present).

The use of “a” or “an” to describe the various elements or components herein is merely for convenience and to give a general sense of the invention. This description should be read to include one or at least one, and the singular also includes the plural unless it is obvious that it is meant otherwise.

The materials, methods, examples, and figures described herein are provided for illustrative purposes only and, except as specifically stated, are not intended to limit the scope of any claim or claim term. The scope of the invention is to be defined only by the language of the recited claims.

### Sweetener Compositions

The invention provides sweetener compositions that comprise (a) a disaccharide carbohydrate or fructose; (b) erythritol; (c) rebaudioside A; and (d) a taste-improving amount of cellulose. In some embodiments, the sweetener compositions comprise a disaccharide carbohydrate and contain no fructose. In other embodiments, the sweetener compositions comprise fructose and contain no disaccharide carbohydrate. In yet other embodiments, the sweetener compositions comprise both a disaccharide carbohydrate and fructose.

As used herein, the term “disaccharide carbohydrate” refers to any sugar having two monosaccharide units. The monosaccharide units may exist as either ketones or aldehydes, and may have either a cyclic or acyclic structure. When a monosaccharide exists as a cyclic structure, the monosaccharide may exist as a hemiacetal or hemiketal, among other forms. Moreover, when a monosaccharide exists as a cyclic structure, either anomer is included within this definition. Illustrative monosaccharides include trioses, tetroses, pentoses, hexoses, heptoses, octoses, and nonoses. In forming a disaccharide, the monosaccharide units may bond to form either reducing disaccharides or non-reducing disaccharides. In some embodiments, the disaccharide carbohydrate includes, but is not limited to, disaccharides containing glucose, fructose, and galactose. In some embodiments, the disaccharide carbohydrate includes, but is not limited to, sucrose, lactose, maltose, trehalose, and isomaltulose. In some embodiments, the disaccharide carbohydrate is isomaltulose.

As used herein, “erythritol” refers to a sugar alcohol well known to those of skill in the art. Erythritol, in either food grade or reagent grade, is readily available through commercial sources.

As used herein, the terms “rebaudioside A” and “Reb A” refer to a steviol glycoside well known to those of skill in the art. In some forms, rebaudioside A may be produced synthetically. Rebaudioside A is conventionally obtained as an extract from portions of stevia plants. Alternatively, rebaudioside A may be produced synthetically. In such extracted forms, the rebaudioside A may also contain amounts of other materials derived from the stevia plant, such as, for example, steviol glycosides (including other steviol glycosides which may contribute to sweetness) and/or botanicals. Therefore, in some embodiments, such as those using rebaudioside A obtained from stevia extracts, the rebaudioside A exists in a form that contains about 60% or more, or about 70% or more, or about 80% or more, or about 90% or more, or about 95% or more, or about 97% or more, or about 98% or more, by weight of rebaudioside A based on the total weight of the material.

As used herein, “cellulose” refers to any cellulosic material known to those of skill in the art. In typical embodiments, the cellulose includes polysaccharides having linear chains of at least several hundred beta-linked D-glucose units. When obtained from commercial sources, for example, the cellulose may exist as a powder. Further, in typical embodiments, the cellulose is insoluble or substantially insoluble in water; yet, in an application like tabletop sweeteners, when incorporated in such an application, it preferably will not detract substantially from the overall product dissolution. Chemically modified celluloses can be employed in the compositions of the invention provided the modifications do not result in water soluble material. The cellulose may have any particle size (or particle size distribution) that is suitable for use in a sweetener composition. For example, in some embodiments, the size of the cellulose particles may range from about 1 micron to about 400 microns, or from about 3 microns to about 300 microns, or from about 5 microns to about 200 microns, or from about 6 microns to about 100 microns. In some embodiments, the insoluble cellulose is a cellulose that if used in amounts exceeding 1% in an aqueous medium can lead to significant viscosity change.

In some embodiments of the invention, a “taste-improving amount” of cellulose is used. This “taste-improving amount” refers to an amount of cellulose that imparts an unexpected improvement in the taste profile of sweetener compositions of the invention. In some instances, for example, the taste improvement may be perceived as an enhancement in the sweetness of the sweetener composition or of the beverage or foodstuff containing the sweetener composition. In other instances, for example, the taste improvement may be perceived as a reduction or masking of the bitterness of the sweetener composition or of the beverage or foodstuff containing the sweetener composition. The taste improvement may also be a combination of both sweetness enhancement and bitterness reduction. In some embodiments of the sweetener compositions, the taste-improving amount of cellulose ranges from about 0.4 weight percent to about 3.0 weight percent, or from about 0.7 weight percent to about 2.0 weight percent, of cellulose, based on the total weight of the sweetener composition. In some embodiments, the sweetener composition contains about 1 weight percent cellulose, based on the total weight of the sweetener composition.

Sweetener compositions of the invention may contain varying amounts of disaccharide and/or fructose; erythritol, honey, and/or evaporated cane juice; and rebaudioside A. The desired amount of each substance may vary depending on, among other factors, the desired use of the sweetener composition, the presence or absence of other components in the sweetener composition, the identity of any disaccharide, if present, and the presence of absence of fructose.

Particular sweetener compositions of the invention contain erythritol. In some embodiments, the sweetener composition contains from about 40 weight percent to about 70 weight percent, or from about 50 weight percent to about 60 weight percent, of erythritol, based on the total weight of the sweetener composition. In other embodiments, the sweetener composition contains from about 50 weight percent to about 60 weight percent, or from about 55 weight percent to about 65 weight percent, of erythritol, based on the total weight of the sweetener composition. In still other embodiments, the sweetener composition contains from about 57 weight percent to about 63 weight percent, or from about 60 weight percent to about 62 weight percent, of erythritol, based on the total weight of the sweetener composition. In some embodiments, the sweetener composition contains about 55 weight percent erythritol, based on the total weight of the sweetener composition. In still other embodiments, the sweetener composition contains about 61-62 weight percent erythritol, based on the total weight of the sweetener composition.

In some embodiments, the sweetener composition contains isomaltulose. In some such embodiments, the sweetener composition contains from about 27 weight percent to about 50 weight percent, or from about 30 weight percent to about 45 weight percent, of isomaltulose, based on the total weight of the sweetener composition. In other such embodiments, the sweetener composition contains from about 30 weight percent to about 38 weight percent, from about 32 weight percent to about 36 weight percent, or from about 33 weight percent to about 35 weight percent of isomaltulose, based on the total weight of the sweetener composition. In some such embodiments, the sweetener composition contains about 41 weight percent of isomaltulose, based on the total weight of the sweetener composition. In still other such embodiments, the sweetener composition contains about 33-34 weight percent of isomaltulose, based on the total weight of the sweetener composition.

Sweetener compositions of the invention contain rebaudioside A. In some embodiments, the sweetener composition contains from about 0.5 weight percent to about 7.0 weight percent, or from about 0.7 weight percent to about 5.0 weight percent, or from about 1.0 weight percent to about 2.5 weight percent, of rebaudioside A, based on the total weight of the sweetener composition. In some embodiments, the sweetener composition contains about 1.3 weight percent of rebaudioside A, based on the total weight of the sweetener composition. The amount of rebaudioside A used will in certain situations depend on the purity of the material. Thus, where the rebaudioside is in the form of, for example, a stevia plant extract containing about 60% by weight Reb A, more of the extract may be desirable to achieve the desired result.

In some embodiments, sweetener compositions of the invention contain (a) from about 38 weight percent to about 43 weight percent of isomaltulose; (b) from about 50 weight percent to about 60 weight percent erythritol; (c) from about 0.75 weight percent to about 1.75 weight percent rebaudioside A; and (d) from about 0.5 weight percent to about 1.5 weight percent cellulose; based on the total weight of the sweetener composition.

In some embodiments, sweetener compositions of the invention contain (a) from about 30 weight percent to about 38 weight percent of isomaltulose; (b) from about 55 weight percent to about 65 weight percent erythritol; (c) from about 0.75 weight percent to about 1.75 weight percent rebaudioside A; and (d) from about 0.5 weight percent to about 1.5 weight percent cellulose; based on the total weight of the sweetener composition.

Sweetener compositions of the invention may also contain amounts of other ingredients in addition to disaccharide and/or fructose, erythritol, rebaudioside A, and cellulose. Such additional ingredients include, but are not limited to, sweetness modifiers, mouthfeel enhancers, flavorants (e.g., vanilla flavorant), and the like. As noted above, honey and/or evaporated cane juice may be used in place of or in combination with the erythritol. Natural flavors and other ingredients are preferred when the product is to be labeled as “all-natural.”

In typical embodiments, sweetener compositions of the invention provide at least one, if not more than one, of the following desirable characteristics: (a) fewer calories per gram than standard table sugar; (b) fewer calories than an amount of standard table sugar perceived as providing comparable sweetness; and (c) lower glycemic index than that of standard table sugar. In some embodiments, the sweetener composition has less than about 5 calories/gram, or less than about 3 calories/gram, or less than about 1 calorie/gram. Also note that “calorie” as used herein refers to the unit of energy commonly appearing on the packaging of food and/or beverage items sold in the United States. The term, as such, does not refer to 1 cal. of energy, but rather corresponds to approximately 1 kcal. of energy. In a typical tabletop sweetener application, for example, the sweetener composition can be packaged in a form where it provides a similar sweetness to about 8 grams of sucrose while providing less than about 5 calories.

In some embodiments, sweetener compositions of the invention contain a plurality of sweetener particles, where such particles contain one or more of the ingredients present in the sweetener composition. In some embodiments, the sweetener composition substantially comprises sweetener particles. In such embodiments, the sweetener composition contains at least about 80 weight percent sweetener particles, or at least about 85 weight percent sweetener particles, or at least about 90 weight percent sweetener particles, based on the total weight of the sweetener composition.

Sweetener particles, when present in the sweetener composition, can have any size suitable for use of the composition as a sweetener. In some embodiments, the average size of the sweetener particles is between about 50 microns and about 1250 microns, or between about 100 microns and about 1000 microns. Screening to eliminate particles of undesired sizes can be carried out during the manufacturing process. Thus, in some embodiments, the particle sizes, after screening to eliminate undesired large particles which may be as large as 1500 μm, may vary up to about 16 mesh, or from about 14 mesh, or from about 12 mesh, based on the standard United States sieve scale. Further, smaller particle sizes, e.g., about 50, 100, or 150 mesh, or even less than about 1 μm, may be present with the larger particles. Screening to eliminate particles having sizes less than, for example, about 100 or 150 mesh can be carried out if desired.

Sweetener particles in the sweetener composition may or may not have uniform composition. Generally, the sweetener compositions of the invention comprise rebaudioside A and an effective amount of cellulose where the composition is a mixture of particles. More specifically, the mixture comprises (a) particles having an erythritol core and (b) particles having a disaccharide core and the Reb A and the cellulose, as well as other components, are predominantly coated on the particles. These coatings on the cores can be either a continuous phase or a discontinuous phase, i.e., where the different coating components form discrete regions in the core coatings.

Thus, in some embodiments, the sweetener composition contains (a) a plurality of first sweetener particles, where the first sweetener particles have (i) an erythritol core, (ii) a first erythritol core-coating layer comprising rebaudioside A and cellulose, and (iii) a second erythritol core-coating layer comprising a disaccharide carbohydrate, where the second erythritol core-coating layer lies outside of the first erythritol core-coating layer; and (b) a plurality of second sweetener particles, where the second sweetener particle has (i) a disaccharide core, (ii) a first disaccharide core-coating layer comprising rebaudioside A and cellulose, and (iii) a second disaccharide core-coating layer comprising a disaccharide carbohydrate, where the second disaccharide core-coating layer lies outside of the first disaccharide core-coating layer. In such embodiments, the core-coating layers may or may not have uniform composition, and may or may not substantially coat the underlying core or layer. In some such embodiments, the first erythritol core-coating layer and/or the first disaccharide core-coating layer have discrete regions of rebaudioside A and cellulose. Also, in some such embodiments, the disaccharide core contains isomaltulose. Further, in some such embodiments, the second erythritol core-coating layer and/or the second disaccharide core-coating layer contain isomaltulose. These sweetener compositions may also contain flavorants (e.g., vanilla flavor), mouthfeel enhancers, and/or sweetness modifiers. When one or more of these are present, the first erythritol core-coating layer and/or the disaccharide core-coating layer may contain one or more of flavorants (e.g., vanilla flavor), mouthfeel enhancers, and/or sweetness modifiers. Moreover, as used herein, the term “layer” may or may not refer to a material that entirely surrounds the underlying material. Thus, a “layer” may be non-uniform in composition and may provide only discontinuous coverage of the underlying material. Moreover, when one layer covers another, the boundary between the layers may or may not be discrete; thus, the boundary between layers may be continuous or semi-continuous.

In the sweetener compositions described in the previous paragraph, the sweetener compositions may or may not contain other particles in addition the plurality of first sweetener particles and the plurality of second sweetener particles. The first sweetener particles and the second sweetener particles may have any particle size that is suitable for use of the composition as a sweetener. In some embodiments, the average size of the first sweetener particles and second sweetener particles is between about 50 microns and about 1250 microns, or between about 100 microns and about 1000 microns. In some embodiments, the particle sizes of the first sweetener particles and the second sweetener particles, after screening to eliminate undesired large particles which may be as large as 1500 μm, will vary up to about 16 mesh, or about 14 mesh, or about 12 mesh. based on the standard United States sieve scale. Further, smaller particle sizes, e.g., about 50, 100, or 150 mesh, or even less than about 1 μm, will be present with the larger particles. In some embodiments, the sweetener composition comprises a mixture of the plurality of first sweetener particles and the second sweetener particles. Such a mixture may or may not contain other types of particles.

The layers in the sweetener composition particles are generally not distinct, i.e., there is no clear demarcation between the first layer and the second layer. For example, the first layer contains Reb A, optional flavoring components, etc, all encased in disaccharide; and the second layer will be predominantly disaccharide with some of the other components. The relative quantities of the various components in the layers, and whether there are layers in the particles, can be modified as necessary by adjusting when during the manufacturing process the components are added.

As noted above, in some embodiments of the invention, the sweetener composition comprises rebaudioside A and a taste-improving amount of cellulose as a mixture, where the mixture comprises (a) particles having an erythritol core and (b) particles having a disaccharide core. In some such embodiments, the disaccharide core comprises isomaltulose. Further, in some such embodiments, the erythritol core and/or the disaccharide core further comprise coating layers having discrete regions of rebaudioside A and cellulose. When such coating layers are present, the coating layers may or may not substantially coat the underlying core material. These particles may have any particle size that is suitable for use of the composition as a sweetener. In some embodiments, the average size of the particles is between about 50 microns and about 1250 microns, or between about 100 microns and about 1000 microns. In some embodiments, the particle sizes of the particles range from about 16 mesh, or from about 14 mesh, or from about 12 mesh to about 100 mesh, based on the standard United States sieve scale.

Sweetener compositions of the invention may have any dissolution rate in water that is suitable for their use as sweeteners. In some embodiments, the sweetener composition can have a dissolution rate in water at 10° C. of between about 100 seconds and about 200 seconds, or between about 125 seconds and about 175 seconds, or between about 140 seconds and 160 seconds, based on the dissolution of about 2 grams of the sweetener composition in 240 mL of water. In some embodiments, the sweetener composition can have a dissolution rate in water at 45° C. of between about 50 seconds and about 150 seconds, or between about 75 seconds and about 125 seconds, or between about 85 seconds and 110 seconds, based on the dissolution of about 2 grams of the sweetener composition in 240 mL of water. In some embodiments, the dissolution rate of the sweetener composition is about 150 seconds at 10° C. and about 96 seconds at 45° C., based on the dissolution of about 2 grams of the sweetener composition in 240 mL of stirred water.

In certain embodiments, the invention provides a package containing a predetermined amount of from about 0.8 grams to about 3.5 grams of a solid sweetener composition, where the predetermined amount of the solid sweetener composition has a sweetness equivalent to about four times (by weight) the predetermined amount of sucrose, and where the solid sweetener composition comprises:

(a) from about 38 weight percent to about 43 weight percent of isomaltulose;

(b) from about 50 weight percent to about 60 weight percent erythritol;

(c) from about 0.75 weight percent to about 1.75 weight percent rebaudioside A; and

(d) from about 0.5 weight percent to about 1.5 weight percent cellulose.

In certain embodiments, the invention provides a package containing a predetermined amount of from about 0.8 grams to about 3.5 grams of a solid sweetener composition, where the predetermined amount of the solid sweetener composition has a sweetness equivalent to about four times (by weight) the predetermined amount of sucrose, and where the solid sweetener composition comprises:

(a) from about 30 weight percent to about 38 weight percent of isomaltulose;

(b) from about 55 weight percent to about 65 weight percent erythritol;

(c) from about 0.75 weight percent to about 1.75 weight percent rebaudioside A; and

(d) from about 0.5 weight percent to about 1.5 weight percent cellulose.

In the packages containing a predetermined amount of the solid sweetener composition, the predetermined amount is about 1 gram and has a sweetness equivalent to about 4 grams of sucrose, or the predetermined amount is about 2 grams and has a sweetness equivalent to about 8 grams of sucrose.

Sweetener compositions of the invention may have any bulk density that is suitable for their use as sweeteners. In some embodiments, the bulk density of the sweetener composition ranges from about 0.5 g/cm³ to about 1.0 g/cm³, or from about 0.7 g/cm³ to about 0.8 g/cm³. In some embodiments, the bulk density of the sweetener composition is about 0.76 g/cm³.

### Methods of Manufacture—Process A

In one aspect, the invention provides a method of manufacturing a sweetener composition comprising: (a) providing a fluid-bed coating apparatus; (b) introducing dry disaccharide carbohydrate, dry erythritol, dry rebaudioside A, and dry cellulose powder to the fluid-bed coating apparatus; (c) charging a substantially all of the dry ingredients in the fluid-bed coating apparatus; (d) spraying a coating solution into the fluid-bed coating apparatus to form coated sweetener particles; and (e) drying the coated sweetener particles.

The process may be carried out in any fluid-bed coating apparatus suitable for carrying out the process. In some embodiments, the method employs a bottom-spray (Wurster) fluid-bed coating apparatus. Other coating devices may be suitable, however, and may be selected according to the knowledge of one of skill in the art.

The dry erythritol, rebaudioside A, and cellulose powder are introduced into the coating apparatus, and then charged. In some embodiments, it may be useful to preheat the fluid bed to lower the fluidizing air dew point, e.g., to about 75° F. The introduction and charging of the dry ingredients may occur by any means suitable for the selected fluid-bed coating apparatus.

A coating solution is sprayed into the fluid bed to form coated sweetener particles. In some embodiments, at least about 80 weight percent, or at least about 90 weight percent, or at least about 95 weight percent, of the particles in the fluid bed are at least partially coated with the coating solution. The coating solution may contain any suitable sweetening agent, including, but not limited to, disaccharides, erythritol, fructose, and the like. In some embodiments, the coating solution comprises isomaltulose. In some embodiments where the coating solution comprises isomaltulose, the coating solution is a solution having from about 20 volume percent to about 40 volume percent, or to about 50 volume percent, or to about 60 volume percent, or to about 70 volume percent solids. Further, in some embodiments where the coating solution comprises isomaltulose, the coating solution is a solution having about 30 volume percent solids. During the spraying step, the fluidizing air rate in the fluid-bed coating apparatus is maintained so as to avoid excessive clumping of coated product, but also to avoid generation of excessive fines, thus reducing the yield of coated particles. A suitable fluidizing air rate will depend, at least in part, on the composition and particle size of the dry ingredients and on the configuration of the coating chamber. In addition, the spray rate of the disaccharide solution is maintained so as to achieve maximum coating with a minimum amount of clumping. A suitable spray rate will depend, at least in part, on the composition and particle size of the dry ingredients and on the configuration of the coating chamber. A suitable spray time will depend, at least in part, on the spray rate, the particle sizes, and the particle composition. In some embodiments, the spray time can range from about 3 minutes to about 15 minutes. In some embodiments, the spray time is about 10-12 minutes. In other embodiments, the spray time is about 4-6 minutes. The coating process may be carried out at any suitable temperature. In some embodiments, the coating is carried out in an environment where the air temperature ranges from about 100° F. to about 150° F. In such environments, the product temperature can be lower, e.g., from about 65° F. to about 85° F.

The disaccharide-coated sweetener particles are dried. In typical embodiments, the drying is conducted in the fluid-bed coating apparatus. In some embodiments, for example, the air temperature in the fluid bed is increased to about 150° F. to permit efficient drying of the coated particles. Other drying temperatures may be suitable, however, depending on the degree of coating, the rate of air flow, and the configuration of the fluid-bed coating apparatus.

In some embodiments, the dried disaccharide-coated particles undergo a screening process to remove excessively small and excessively large particles. The desired particle size will depend on the intended use of the sweetener composition. In some embodiments, for example, the dried coated particles are screened to remove substantially all particles smaller than about 100 mesh and substantially all particles larger than about 16 mesh, or larger than about 14 mesh, or larger then about 12 mesh (based on standard United States sieve scale). The screening may occur in any suitable screening apparatus, e.g., a Sweco screening apparatus. In some instances, excessively large particles may result from clumping and/or balling. In some embodiments, such excessively large particles resulting from clumping and/or balling may be broken up by the application of force.

In some embodiments, the process may include the addition of one of more sweetness modifiers, mouthfeel enhancers, and/or flavorants (e.g., vanilla flavorant). In some such embodiments, one or more sweetness modifiers, mouthfeel enhancers, and/or flavorants (e.g., vanilla flavorant) are added as dry ingredients and are introduced into the fluid-bed coating apparatus with the dry erythritol, the dry cellulose, and the dry disaccharide. In other such embodiments, one or more sweetness modifiers, mouthfeel enhancers, and/or flavorants (e.g., vanilla flavorant) are added into the disaccharide coating solution and sprayed onto the dry particles.

### Methods of Manufacture—Process B

In one aspect, the invention provides a method of manufacturing a sweetener composition comprising: (a) providing a fluid-bed coating apparatus; (b) introducing dry disaccharide carbohydrate, dry erythritol, and dry rebaudioside A to the fluid-bed coating apparatus; (c) charging a substantially all of the dry ingredients in the fluid-bed coating apparatus; (d) spraying a coating solution into the fluid-bed coating apparatus to form coated sweetener particles; (e) during the spraying step, introducing dry cellulose powder to the fluid-bed coating apparatus; and (f) drying the coated sweetener particles.

The process may be carried out in any fluid-bed coating apparatus such as described above.

The dry erythritol and rebaudioside A are introduced into the coating apparatus, and then charged. In some embodiments, it may be useful to preheat the fluid bed to lower the fluidizing air dew point, e.g., to about 75° F. The introduction and charging of the dry ingredients may occur by any means suitable for the selected fluid-bed coating apparatus.

A substantial portion of the dry ingredients in the fluid-bed coating apparatus are coated with a coating solution, as described above. The coating solution may contain any suitable sweetening agent, including, but not limited to, disaccharides, erythritol, fructose, and the like. In some embodiments, the coating solution comprises isomaltulose, as described above. The fluidizing air rate and the spray rate are maintained as described above. The coating process may be carried out at any suitable temperature. In some embodiments, the coating is carried out in an environment with an air temperature that ranges from about 100° F. to about 150° F., and with a product temperature that ranges from about 65° F. to about 85° F.

The dry cellulose is introduced into the fluid bed during the spraying process. The spraying process is described above. The means of introducing the dried cellulose will vary depending on the model of fluid-bed coating apparatus. In some embodiments, the dried cellulose powder is sucked into the fluid bed. The dried cellulose may be introduced at any time during the coating process. In some embodiments, though, the cellulose is not introduced at the beginning of the coating process. In some such embodiments, the dried cellulose powder is not introduced until the latter half of the coating cycle.

The disaccharide-coated sweetener particles are dried. In typical embodiments, the drying is conducted in the fluid-bed coating apparatus. In some embodiments, for example, the temperature in the fluid bed is increased to about 150° F. to permit efficient drying of the coated particles. Other drying temperatures may be suitable, however, depending on the degree of coating, the rate of air flow, and the configuration of the fluid-bed coating apparatus.

In some embodiments, the dried disaccharide-coated particles undergo a screening process to remove excessively small and excessively large particles, as described above. In some instances, excessively large particles may result from clumping and/or balling. In some embodiments, such excessively large particles resulting from clumping and/or balling may be broken up by the application of force.

In some embodiments, the process may include the addition of one of more sweetness modifiers, mouthfeel enhancers, and/or flavorants (e.g., vanilla flavorant). In some such embodiments, one or more sweetness modifiers, mouthfeel enhancers, and/or flavorants (e.g., vanilla flavorant) are added as dry ingredients and are introduced into the fluid-bed coating apparatus with the dry erythritol and the dry disaccharide. In other such embodiments, one or more sweetness modifiers, mouthfeel enhancers, and/or flavorants (e.g., vanilla flavorant) are added into the disaccharide coating solution and sprayed onto the dry particles.

### Use of Sweetener Compositions

The sweetener compositions of the invention may be used to sweeten various consumable food and beverage items. In some embodiments, the sweetener composition is used to sweeten a beverage by introducing the sweetener composition to a beverage. Suitable beverages include, but are not limited to, coffee, tea, tisane, carbonated beverages, juices, smoothies, sports drinks, protein shakes, frozen drinks, flavored drinks (e.g., lemonade), nutritional and dietary supplements, and the like. This introduction of the sweetener composition can occur at any time, for example, during the packaging (e.g., bottling) of the beverage or immediately prior to consumption. In a similar manner, the sweetener compositions may also be introduced to various liquid-based medicines and pharmaceutical products, including both over-the-counter drugs and prescription drugs. In other embodiments, the sweetener composition is used to sweeten a solid (including semi-solid) food item by introducing the sweetener composition to a solid food item, a nutritional product, or a dietary supplement. Suitable solid food items include, but are not limited to, ice cream, pudding, gelatin food items, powdered mixes, fruit, cereal, candy, cookies, cakes, and the like. This introduction of the sweetener composition can occur at any time, for example, during the preparation of the food item (e.g., introduction to cake or cookie batter) or immediately before consumption (e.g., introduction to fresh fruit or cold cereal).

### Products Containing Sweetener Compositions

The invention provides a packaged sweetener formulation containing a sweetener composition of the invention. To yield a packaged sweetener formulation, the sweetener composition can be packaged in any manner known to those of skill in the art. In some embodiments, for example, the sweetener composition is introduced in a paper sachet or paper stick, where the sachet contains an amount of the sweetener composition that provides a comparable sweetness to about 4 grams of table sugar. In some embodiments, for example, about 2 grams of the sweetener composition will provide a sweetness comparable to that of 8 grams of table sugar. In other embodiments, the sweetener composition is introduced into a larger box, bag, or jar that is suitable for sale on a grocery store shelf. In some embodiments, the packaged sweetener formulation contains the sweetener composition and another known sweetener. Other embodiments of such sweeteners may include tablets. Such embodiments can use any other sweetener known to those of skill in the art, including, but not limited to, sucrose, fructose, sucralose, saccharin, aspartame, other steviol glycosides, and the like.

Tablets of the sweetener composition of the invention may contain, for example, from about 45-300 mg of the composition. Jars and bags of the composition may contain, for example, from about 80-300 grams of the composition.

The invention also provides a food product containing a sweetener composition of the invention. Such food products include both beverages and solid food items, such as those described above.

The invention also provides pharmaceutical formulations containing a sweetener compositions of the invention. These pharmaceutical formulations include both over-the-counter and prescription drugs, and include both liquid formulations and solid formulations (e.g., tablets, caplets, gel-caps, etc.)

### EXAMPLES

The following examples provide illustrative embodiments of the inventions described and claimed herein. These examples are not intended to provide any limitation on the scope of the invented subject matter. The scope of the invention shall be limited only by the language of the claims.

The compositions of Examples 1-4 can be prepared using either manufacturing Process A or Process B described above. Examples 6 and 7 correspond to Processes A and B respectively, and describe certain aspects of those processes or the equipment they employ in more detail.

### Example 1

### Sweetener Composition A

A sweetener composition according to the invention is shown below in Table 1.

TABLE 1

| Ingredient | Supplier | Weight % |
|---|---|---|
| Erythritol, F-8015 | Jungbunzlauer | 55.06 |
| Isomaltulose, in dry fluid bed | Palatinit | 38.00 |
| Isomaltulose, used as 30% solids solution | Palatinit | 3.00 |
| for liquid spray coating | | |
| Rebaudioside A, dry, 97% | PureCircle | 1.30 |
| Cellulose, Ticacel-100 | TIC | 1.00 |
| Nat. Sweet Modifier AL1101261, dry | Givaudan | 0.90 |
| Nat. Mouthfeel Enhancer ZO6227600 (PK), | Givaudan | 0.44 |
| dry | | |
| Nat. Vanilla Flavor 926.0327, dry | FONA | 0.30 |

The composition described in Table 1 is free-flowing, appears to have a crystalline form, and has a sweetness equivalent value of 2.0 grams=8 grams sugar. The composition can be packaged into sachets or sticks as serving sizes of, for example, 2.0 grams.

### Example 2

### Sweetener Composition B

A sweetener composition according to the invention is shown below in Table 2.

TABLE 2

| Ingredient | Supplier | Weight % |
|---|---|---|
| Erythritol | Cargill | 60.06 |
| Isomaltulose, in dry fluid bed | Palatinit | 34.00 |
| Isomaltulose, used as 30% solids solution for | Palatinit | 2.00 |
| liquid spray coating | | |
| Rebaudioside A, dry, 97% | PureCircle | 1.30 |
| Cellulose, Ticacel-100 | TIC | 1.00 |
| Nat. Sweet Modifier AL1101261, dry | Givaudan | 0.90 |
| Nat. Mouthfeel Enhancer ZO6227600 (PK), dry | Givaudan | 0.44 |
| Nat. Vanilla Flavor 926.0327, dry | FONA | 0.30 |

The composition described in Table 2 is free-flowing, appears to have a crystalline form, and has a sweetness equivalent value of 2.0 grams=8 grams sugar. The composition can be packaged into sachets or sticks as serving sizes of, for example, 2.0 grams.

### Example 3

### Sweetener Composition C

A sweetener composition according to the invention is shown below in Table 3. This example shows the quantity of each ingredient required to result in a 5 Kg batch of product.

TABLE 3

| | | | Batch |
|---|---|---|---|
| Description | Supplier | Weight % | (grams) |
| Erythritol | Jungbunzlauer | 61.40 | 3070.0 |
| Isomaltulose, in dry fluid bed | Palatinit | 33.30 | 1665.0 |
| Isomaltulose, used as 30% solids | Palatinit | 3.00 | 150.0 |
| solution for liquid spray coating | | | |
| Reb-A 97% | PureCircle | 1.30 | 65.0 |
| Cellulose Powder Ticacel-100 | TIC | 1.00 | 50.0 |
| Total | | 100 | 5000.0 |

The composition described in Table 3 is free-flowing and appears crystalline. The composition has a sweetness equivalent value of 2.0 grams=8 grams sugar. The composition can be packaged into sachets or sticks as serving sizes of, for example, 2.0 grams.

### Example 4

### Sweetener Composition D

A sweetener composition according to the invention is shown below in Table 4.

TABLE 4

| Description | Supplier | Weight % |
|---|---|---|
| Erythritol | Jungbunzlauer | 61.40 |
| Isomaltulose, in dry fluid bed | Palatinit | 34.00 |
| Reb-A 97% | PureCircle | 1.30 |
| Cellulose Powder Ticacel-100 | TIC | 1.00 |
| Nat. Sweet Modifier AL1101261, | Givaudan | 0.90 |
| dry | | |
| Nat. Mouthwatering FL 540293 | Firmenich | 0.440 |
| TP1200, Dry | | |
| Nat. Mouthfeel Enhancer | Givaudan | 0.440 |
| ZO6227600 (PK), dry | | |
| Nat. Masking Flavor 540294 | Firmenich | 0.220 |
| TP1900, Dry | | |
| Nat. Vanilla Flavor 926.0327, dry | FONA | 0.300 |

The composition described in Table 4 is free-flowing and appears crystalline. The composition has a sweetness equivalent value of 2.0 grams=8 grams sugar. The composition can be packaged into sachets or sticks as serving sizes of, for example, 2.0 grams.

### Example 5

### Sweetener Particles

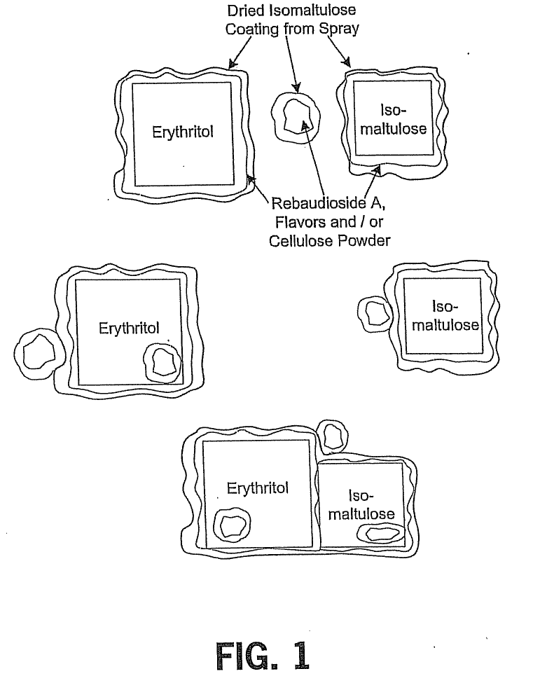

FIG. 1 is an illustration of sweetener particles prepared according either of the processes described above. FIG. 1 depicts sweetener particles having cores of erythritol and cores of isomaltulose. Those particles are then coated by two coating layers. The inner coating layer contains rebaudioside A, flavorant, and/or cellulose. The outer layer contains isomaltulose from a spray coating process. As shown in the FIG. 1, particles lacking erythritol or isomaltulose cores may form in some instances.

### Example 6

### A Manufacturing Process

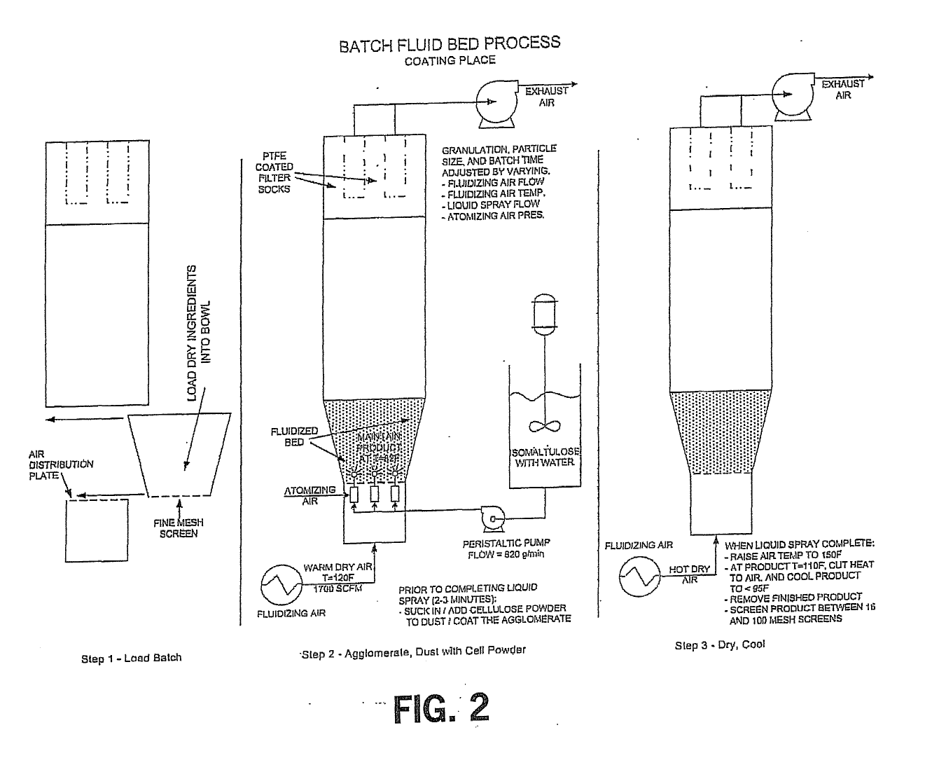

The process is carried out using a three-nozzle Model 3200 Wurster fluid bed. The fluid bed uses a bottom spray with PTFE coating filter socks. FIG. 2 shows such a fluid-bed coating apparatus and also depicts illustrative process steps. A fluidizing distribution plate is set up for coating process with higher air flow at the center. The air is cycled back through the filter socks in knock-back mode to reduce build-up of fines.

An isomaltulose coating syrup is prepared by mixing isomaltulose with purified water to obtain a 30% solids solution. The mixture is heated to room temperature to aid in dissolution.

The dry ingredients are introduced into a bowl, as shown in Step 1 in FIG. 2. The dry ingredients include erythritol, isomaltulose, rebaudioside A, cellulose powder, and any other additives (e.g., sweetness modifier, mouthfeel enhancer, flavorant, and the like).

The fluid bed is preheated to about 75° F. The dry ingredients are charged to the fluid bed, and are fluidized and blended for several minutes. The dry product is maintained at a temperature of about 82° F., and the fluidizing air temperature ranges from about 100 to about 150° F. The isomaltulose coating syrup is introduced through the bottom of the fluid bed with a spray rate of 780-850 g/min and an atomizing air pressure of about 60 psi. The coating process is carried out until the dry particles are substantially coated by the coating syrup (e.g., about 4-6 minutes). When the coating step is complete, the fluidizing air temperature is increased to about 150° F. to dry the product. Once the product is dry, the temperature is reduced.

The product is screened using a Sweco screening apparatus. Only particles having a size between 16 mesh (or 14 mesh, or 12 mesh) and 100 mesh are accepted (based on standard United States sieve scale). If any clumping or balling has occurred, the larger particles are broken up on the screen.

### Example 7

### A Manufacturing Process

The process is carried out using a three-nozzle Model 3200 Wurster fluid bed. The fluid bed uses a bottom spray with PTFE coating filter socks. FIG. 2 shows such a fluid-bed coating apparatus and also depicts illustrative process steps. A fluidizing distribution plate is set up for coating process with higher air flow at the center. The air is cycled back through the filter socks in knock-back mode to reduce build-up of fines.

An isomaltulose coating syrup is prepared by mixing isomaltulose with purified water to obtain a 30% solids solution. The mixture is heated to room temperature to aid in dissolution.

The dry ingredients are introduced into a bowl, as shown in Step 1 in FIG. 2. The dry ingredients include erythritol, isomaltulose, rebaudioside A, and any other additives (e.g., sweetness modifier, mouthfeel enhancer, flavorant, and the like).

The fluid bed is preheated to about 75° F. The dry ingredients are charged to the fluid bed, and are fluidized and blended for several minutes. The dry product is maintained at a temperature of about 82° F., and the fluidizing air temperature ranges from about 100 to about 150° F. The isomaltulose coating syrup is introduced through the bottom of the fluid bed with a spray rate of 780-850 g/min and an atomizing air pressure of about 60 psi. The coating process is carried out until the dry particles are substantially coated by the coating syrup (e.g., about 4-6 minutes). When about 2-3 minutes remain in the coating process, cellulose powder is sucked into the fluid bed, where it attaches to the outside of partially coated particles in the fluid bed. The coating process continues for an additional 2-3 minutes after introduction of the cellulose powder. When the coating step is complete, the fluidizing air temperature is increased to about 150° F. to dry the product. Once the product is dry, the temperature is reduced.

The product is screened using a Sweco screening apparatus. Only particles having a size between 16 mesh (or 14 mesh, or 12 mesh) and 100 mesh are accepted (based on standard United States sieve scale). If any clumping or balling has occurred, the larger particles are broken up on the screen.

### Example 8

### Taste Improvement from Cellulose

The compositions of the invention can be tested by means of product sampling. Such techniques are well known to those of skill in the art. With such tests, it can be demonstrated, for example, that the inclusion of a taste-improving amount of cellulose into the sweetener composition yields a sweetener composition that more closely approximates the taste profile of sugar than compositions lacking a taste-improving amount of cellulose. Further, such tests can also demonstrate an overall improvement in the taste of products being sweetened by the compositions of the invention.

What is claimed is:

1. A sweetener composition comprising:
(a) a disaccharide carbohydrate;
(b) erythritol;
(c) rebaudioside A; and
(d) a taste-improving amount of cellulose.

2. A sweetener composition according to claim 1 where the disaccharide carbohydrate is selected from the group consisting of sucrose, lactose, maltose, trehalose, and isomaltulose.

3. A sweetener composition according to claim 1 where the sweetener composition comprises between about 40 weight percent and about 70 weight percent erythritol.

4. A sweetener composition according to claim 2 where the sweetener composition comprises between about 27 weight percent and about 50 weight percent isomaltulose.

5. A sweetener composition according to claim 4 where the sweetener composition comprises about 34 weight percent isomaltulose.

6. A sweetener composition according to claim 4 where the sweetener composition comprises about 41 weight percent isomaltulose.

7. A sweetener composition according to claim 1 where the sweetener composition comprises between about 0.5 weight percent and about 7.0 weight percent rebaudioside A.

8. A sweetener composition according to claim 13 where the sweetener composition comprises between about 1.0 weight percent and about 2.5 weight percent rebaudioside A.

9. A sweetener composition according to claim 8 where the sweetener composition comprises about 1.3 weight percent rebaudioside A.

10. A sweetener composition according to claim 1 where the sweetener composition comprises between about 0.4 weight percent and about 3.0 weight percent cellulose.

11. A sweetener composition according to claim 16 where the sweetener composition comprises between about 0.7 weight percent and about 2.0 weight percent cellulose.

12. A sweetener composition according to claim 11 where the sweetener composition comprises about 1.0 weight percent cellulose.

13. A sweetener composition according to claim 1 further comprising less than about 2 weight percent of a sweetness modifier.

14. A sweetener composition according to claim 1 further comprising less than about 1 weight percent of a flavorant.

15. A sweetener composition according to claim 1 where the sweetener compositions substantially comprises sweetener particles.

16. A sweetener composition according to claim 15 where the sweetener particles have an average particle size of between about 50 microns and about 1250 microns.

17. A sweetener composition according to claim 1 where the sweetener composition has less than about 5 calories per gram.

18. A sweetener composition comprising:
(a) a plurality of first sweetener particles, where the first sweetener particles have (i) an erythritol core, (ii) a first erythritol core-coating layer comprising rebaudioside A and cellulose, and (iii) a second erythritol core-coating layer comprising a disaccharide carbohydrate, where the second erythritol core-coating layer lies outside of the first erythritol core-coating layer; and
(b) a plurality of second sweetener particles, where the second sweetener particle has (i) a disaccharide core, (ii) a first disaccharide core-coating layer comprising rebaudioside A and cellulose, and (iii) a second disaccharide core-coating layer comprising a disaccharide carbohydrate, where the second disaccharide core-coating layer lies outside of the first disaccharide core-coating layer.

19. A sweetener composition according to claim 18 where the sweetener composition comprises a mixture of the plurality of first sweetener particles and the plurality of second sweetener particles.

20. A sweetener composition according to claim 18 where the disaccharide core comprises isomaltulose.

21. A sweetener composition according to claim 18 where the plurality of first sweetener particles and the plurality of second sweetener particles have an average particle size between about 50 microns and about 1250 microns.

22. A method of manufacturing a sweetener composition comprising:
(a) providing a fluid-bed coating apparatus;
(b) introducing dry disaccharide carbohydrate, dry erythritol, dry rebaudioside A;
(c) charging a substantially all of the dry ingredients in the fluid-bed coating apparatus;
(d) spraying a coating solution into the fluid-bed coating apparatus to form coated sweetener particles; and
(e) drying the coated sweetener particles.

23. A method according to claim 22 where the dry disaccharide comprises isomaltulose.

24. A method according to claim 22 where the coating solution comprises isomaltulose.

25. A method according to claim 22, wherein in part (b) dry cellulose is introduced into the fluid-bed coating apparatus with the dry disaccharide carbohydrate, dry erythritol, and dry rebaudioside A.

26. A method according to claim 22, wherein dry cellulose powder is introduced into the fluid-bed coating apparatus during the spraying in part (d).

27. A method for using a sweetener composition comprising introducing the sweetener composition of claim 1 to a consumable product to be sweetened.

28. A packaged sweetener formulation comprising a sweetener composition according to claim 1.

29. A food product comprising a sweetener composition according to claim 1.

30. A sweetener composition comprising rebaudioside A and a taste-improving amount of cellulose as a mixture, where the mixture comprises (a) particles having an erythritol core and (b) particles having a disaccharide core.

31. A sweetener composition comprising:
(a) from about 30 weight percent to about 43 weight percent of isomaltulose;
(b) from about 50 weight percent to about 70 weight percent erythritol;
(c) from about 0.75 weight percent to about 1.75 weight percent rebaudioside A; and
(d) from about 0.5 weight percent to about 1.5 weight percent cellulose.

32. A sweetener composition according to claim 1 comprising:
(a) a disaccharide carbohydrate or fructose;
(b) erythritol;
(c) rebaudioside A; and
(d) a taste-improving amount of cellulose.

33. A tabletop sweetener product comprising a sweetener according to claim 31;
wherein the tabletop sweetener product is packaged in an amount from about 0.8 grams to about 3.5 grams to provide an equivalent sweetness to about 4 grams to about 8 grams of sucrose.

34. A tabletop sweetener product according to claim 33 where the tabletop sweetener product is packaged in a packaging selected from the group consisting of sachets, sticks, jars, tablets, and bags.

35. A package containing a predetermined amount of from about 0.8 grams to about 3.5 grams of a solid sweetener composition, where the predetermined amount of the solid sweetener composition has a sweetness equivalent to about four times by weight the predetermined amount of sucrose, and where the solid sweetener composition comprises:
(a) from about 30 weight percent to about 43 weight percent of isomaltulose;
(b) from about 50 weight percent to about 70 weight percent erythritol;
(c) from about 0.75 weight percent to about 1.75 weight percent rebaudioside A; and
(d) from about 0.5 weight percent to about 1.5 weight percent cellulose.

36. The package according to claim 35 where the predetermined amount is about 1 gram and has a sweetness equivalent to about 4 grams of sucrose.
